(19) United States
(12) Patent Application Publication
(10) Pub. No.: US 2025/0075980 A1
(43) Pub. Date: Mar. 6, 2025

(54) COOLING SYSTEM FOR DECOATER CYCLONE DUST AND RELATED METHODS

(71) Applicant: Novelis Inc., Atlanta, GA (US)

(72) Inventor: JungYoung Son, Ulsan (KR)

(73) Assignee: Novelis Inc., Atlanta, GA (US)

(21) Appl. No.: 18/726,538

(22) PCT Filed: Nov. 30, 2022
(86) PCT No.: PCT/US2022/080693

§ 371 Date: Jul. 3, 2024

Related U.S. Application Data
(60) Provisional application No. 63/266,465, filed on Jan. 6, 2022.

(51) Int. Cl. F27D 15/02; C22B 1/00; F27D 17/00; F27D 19/00

(52) U.S. Cl. CPC F27D 15/0206; F27D 17/30; F27D 19/00; C22B 1/005; F27D 17/25; F27D 2019/0003

(57) ABSTRACT

A cooling system includes a sensor and a cooling conveyor. The sensor measures a dust characteristic of dust discharged from a dust cyclone of a decoating system. The cooling conveyor receives the dust from the dust cyclone and cools the dust at a cooling rate, and the cooling rate may be controlled based on the measured dust characteristic. A method of cooling dust from a dust cyclone of a decoating system with a cooling system includes measuring a dust characteristic of the dust discharged from the dust cyclone and into a cooling conveyor of the cooling system. The method also includes advancing the dust along the cooling conveyor and cooling the dust at a cooling rate based on the measured dust characteristic.

### REFERENCE TO RELATED APPLICATION

This application claims the benefit of U.S. Provisional Patent Application No. 63/266,465, filed on Jan. 6, 2022, and entitled COOLING SYSTEM FOR DECOATER CYCLONE DUST AND RELATED METHODS, the content of which is hereby incorporated by reference in its entirety.

### FIELD OF THE INVENTION

This application relates to metal recycling, and more particularly to decoating systems for metal recycling.

### BACKGROUND

During metal recycling, metal scrap (such as aluminum or aluminum alloys) is crushed, shredded, chopped, or otherwise reduced into smaller pieces of metal scrap. Oftentimes, the metal scrap has various coatings, such as oils, paints, lacquers, plastics, inks, and glues, as well as other organic contaminants such as paper, plastic bags, polyethylene terephthalate (PET), sugar residues, etc., that must be removed through a decoating process before the metal scrap can be further processed and recovered.

During decoating with a decoating system, the non-volatile organic compounds are thermally cracked and some of the organic compounds are condensed and removed as dust, along with other finely divided materials (aluminum fines, clay, glass, various inorganic materials such as pigments, etc.), through a dust cyclone of the decoating system. Because this dust contains a high concentration of organic compounds and other combustibles such as metallic powder and is at an elevated temperature (due to the decoating process), the dust is susceptible to combustion and the creation of dust fires when it is discharged from the decoating system. These fires are very difficult to extinguish, even with water or fire extinguishers. Moreover, if water were used to wet the dust to make a slurry mixture of the water and dust, the mixture may be costly to dispose of due to the content of the slurry mixture, the process may be costly to implement because of the quantity of water needed on a daily basis, and the mixture may present potential safety and environmental issues.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a cooling system includes a sensor for measuring a dust characteristic of dust discharged from a dust cyclone of a decoating system. The cooling system also includes a cooling conveyor for receiving the dust from the dust cyclone and cooling the dust at a cooling rate. In various embodiments, the cooling system may control the cooling rate based on the measured dust characteristic.

According to some embodiments, a decoating system includes a dust cyclone and a cooling system. The dust cyclone may receive an exhaust gas from a decoating kiln, filter particulate matter from the exhaust gas as dust, and discharge the dust. The cooling system includes a sensor and a cooling conveyor. The sensor may measure a dust characteristic of the dust discharged from the dust cyclone, and the cooling conveyor may receive the dust discharged from the dust cyclone and cool the dust at a cooling rate. In certain embodiments, the cooling system controls the cooling rate based on the measured dust characteristic.

According to various embodiments, a method of cooling dust from a dust cyclone of a decoating system with a cooling system includes measuring a dust characteristic of the dust discharged from the dust cyclone and into a cooling conveyor of the cooling system. The method includes advancing the dust along the cooling conveyor and cooling the dust at a cooling rate based on the measured dust characteristic.

According to certain embodiments, a cooling system includes a cooling conveyor having a trough and a screw within the trough, where the screw is rotatable within the trough. In various embodiments, at least one of the screw or the trough is internally cooled with a coolant and includes a coolant inlet and a coolant outlet. The cooling conveyor may receive dust discharged from a dust cyclone of a decoating system and cool the dust at a cooling rate. The cooling system also includes a sensor for measuring a characteristic of the coolant. In certain embodiments, the cooling system may control the cooling rate based on the measured characteristic of the coolant.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a decoating system with a cooling system according to embodiments.

FIG. 2 illustrates a decoating system with a cooling system according to embodiments.

FIG. 3 illustrates a screw of a cooling system according to embodiments.

FIG. 4 illustrates a trough of a cooling conveyor according to embodiments.

FIG. 5 illustrates a decoating system with a cooling system according to embodiments.

### DETAILED DESCRIPTION

Described herein are cooling systems for decoating systems for metal recycling and associated methods. While the cooling systems are described with decoating systems for metal recycling, they are not so limited and may be used with other systems as desired. In certain aspects, the cooling systems provided herein may provide improved cooling of dust within a cooling conveyor, and the cooling systems optionally may provide variable cooling based on one or more characteristics of the dust. Compared to traditional systems, the cooling systems provided herein may minimize water or coolant that is directly sprayed into the cooling conveyor, which may remove or minimize the risk of dust fires while also minimizing environmental issues (e.g., contaminated water that may leak out of the dust). In some embodiments, the cooling systems may have a shorter length compared to traditional systems, which may be easier to install while still eliminating or minimizing dust fires. In some embodiments, the cooling systems described herein may enable cooling of dust to a target cooled temperature regardless of an inlet temperature of the dust. Various other benefits and advantages may be realized with the cooling systems described herein, and the aforementioned description should not be considered limiting.

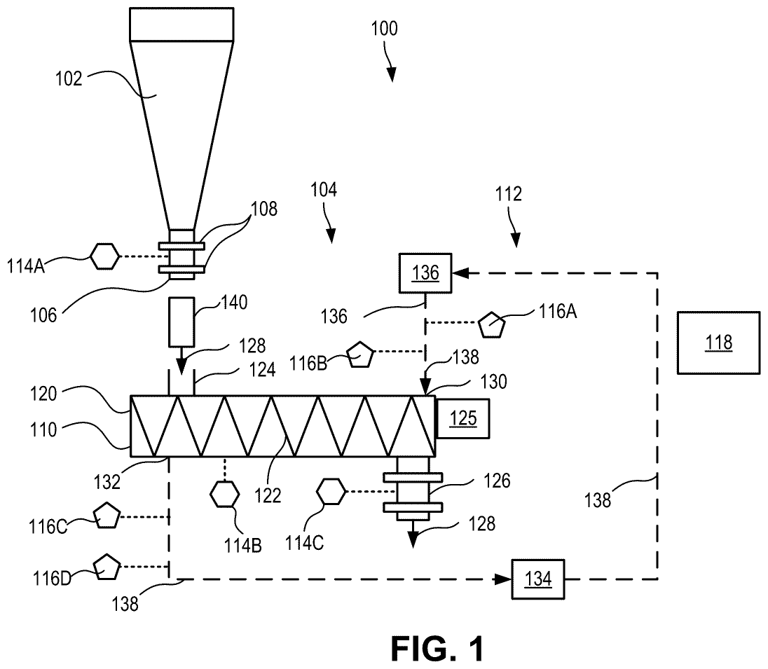

FIG. 1 illustrates a decoating system 100 having a dust cyclone 102 and a cooling system 104 according to various embodiments. In certain aspects, the decoating system 100 may be used to remove coatings from metal scrap. The decoating system 100 generally includes a dust cyclone 102 and a cooling system 104. While not illustrated in FIG. 1, in various embodiments, the decoating system 100 may include other components or systems for removing coatings from the metal scrap, including but not limited to a kiln, an afterburner, a gas recirculation system, a gas exhaust system, combinations thereof, and/or other combinations of components or systems as desired.

The dust cyclone 102 may receive an exhaust gas from the kiln of the decoating system 100 and separate larger particulates from the exhaust gas as dust. As illustrated in FIG. 1, the dust cyclone 102 includes an outlet 106, and the dust cyclone 102 may discharge the separated particulates through the outlet 106 as dust. In certain embodiments, the particulates separated from the exhaust gas may include various metallic solids, non-metallic solids, and/or carbonaceous material. In some embodiments, the dust particulates optionally may have a diameter of less than 500 microns, such as less than 400 microns, less than 300 microns, less than 200 microns, and/or less than 100 microns; however, in other embodiments, the dust separated by the dust cyclone 102 may have other diameters as desired. In certain embodiments, the dust cyclone 102 may separate the particulates from the exhaust gas and discharge the dust while the dust is at elevated temperatures. In certain embodiments, the dust discharged from the dust cyclone 102 may be discharged at a temperature of from about 250° C. to about 400° C., which may be an inlet temperature of the dust for the cooling system 104. Optionally, the dust cyclone 102 may include dampers 108 for controlling the rate and/or timing at which the dust is discharged from the dust cyclone 102. The particular dust cyclone 102 illustrated in FIG. 1 should not be considered limiting, and the dust cyclone 102 may be various suitable solid/gas separators as desired.

The cooling system 104 receives the dust that is discharged from the dust cyclone 102 and cools it from the inlet temperature to a cooled temperature. The cooled temperature is a temperature below an ignition temperature of the dust, which in certain embodiments may be from about 175° C. to about 300° C. In various examples, the cooled temperature is less than about 150° C., such as less than about 100° C. In some examples, the cooled temperature is about 50° C. By cooling the dust to a dust processing temperature below an ignition temperature of the dust, the cooling system 104 may reduce and/or eliminate the risk of dust fires and allow the dust to be further processed as desired. Optionally, and as discussed in detail below, a cooling rate at which the cooling system 104 cools the dust may be variable and/or adjustable. The variable cooling rate provided by the cooling system 104 may allow the dust to be cooled to a predetermined cooled temperature regardless of the inlet temperature of the dust, and/or may allow for the cooling system 104 to have a compact size.

As illustrated in FIG. 1, in various embodiments, the cooling system 104 includes a cooling conveyor 110 that receives the dust discharged from the dust cyclone 102 and a coolant system 112 that supplies a coolant to the cooling conveyor 110. The cooling system 104 may optionally include a dust sensor 114, a coolant sensor 116, and/or a controller 118 as discussed in detail below.

The cooling conveyor 110 may be any suitable type of conveyor that may receive the dust from the dust cyclone 102. In the example illustrated in FIG. 1, the cooling conveyor 110 is a screw conveyor with a trough 120 and a screw 122. The trough 120 includes an inlet 124 and an outlet 126, and the screw 122 is within the trough 120. The cooling conveyor 110 includes a driving means 125 for rotating the screw 122 within the trough 120, and rotation of the screw 122 within the trough 120 may move the dust through the cooling conveyor 110 from the inlet 124 to the outlet 126. The driving means 125 may be various suitable devices or mechanisms for rotating the screw 122, including but not limited to a motor or an engine. Arrows 128 in FIG. 1 represent movement of the dust through the cooling conveyor 110. In some optional embodiments, the cooling conveyor 110 may be inclined along its length (i.e., in a direction from the inlet 124 to the outlet 126), which may further improve cooling provided by the cooling conveyor 110. In other embodiments, the cooling conveyor 110 need not be at an incline.

While a screw conveyor is illustrated as the cooling conveyor 110 in FIG. 1, in other examples, the cooling conveyor 110 may be other types of conveyors as desired, including but not limited to a bucket conveyor, a vibratory conveyor, and/or various other types of conveyors suitable for receiving the dust from the dust cyclone 102. In some examples, the decoating system 100 may include a plurality of conveyors, which may or may not be the same type of conveyor. In other examples, various other devices or components that can cool the dust may be used in addition to the cooling conveyor 110 or without the cooling conveyor 110. As one non-limiting example, in some cases, various mixers, such as a ribbon mixer, with various cooling features may be used in place of or in addition to the cooling conveyor 110.

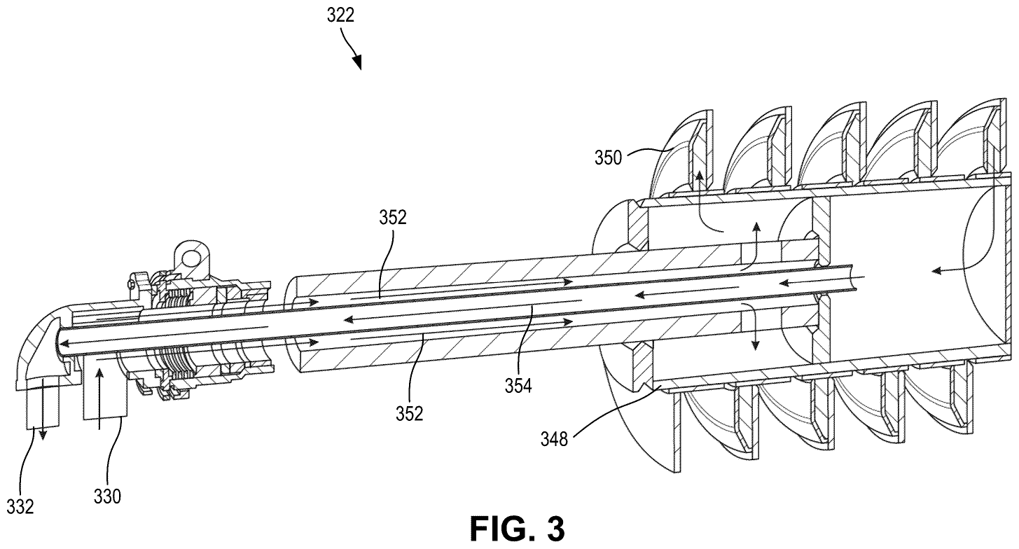

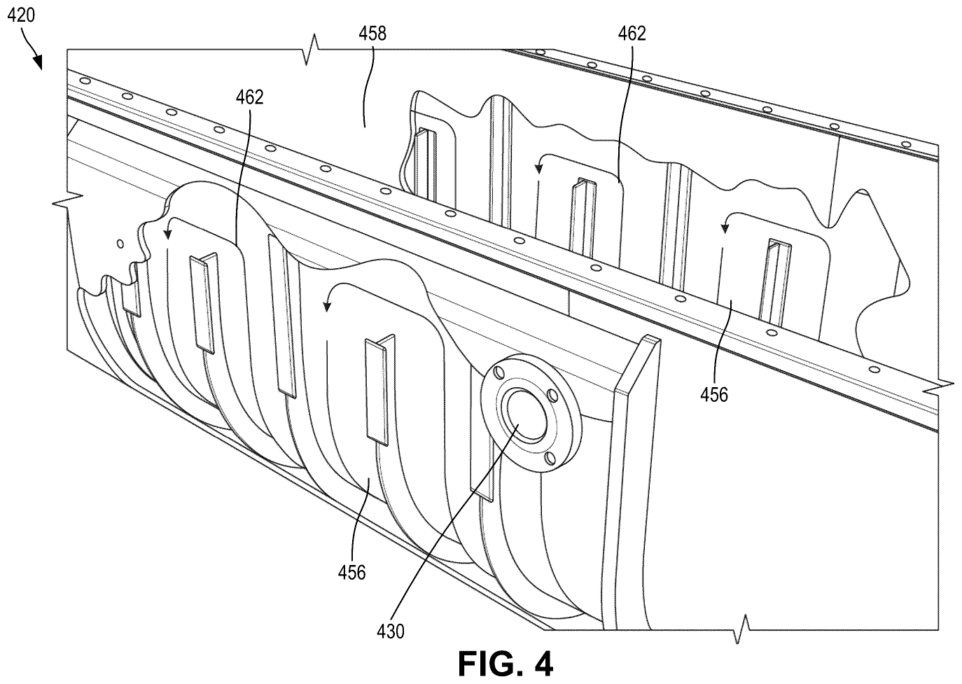

In certain embodiments, at least one component of the cooling conveyor 110 is internally cooled to provide a cooled surface that contacts the dust, thereby cooling the dust as the dust is moved through the cooling conveyor 110. In these embodiments, the cooling conveyor 110 includes a coolant inlet 130 and a coolant outlet 132, and the coolant system 112 is in fluid communication with at least the coolant inlet 130 such that the coolant is provided from a coolant cooling and/or supply system 134 of the coolant system 112 to the cooling conveyor 110. Optionally, and as illustrated in FIG. 1, the coolant system 112 is in fluid communication with the coolant outlet 132 such that heated coolant exiting the coolant outlet 132 may be directed to the coolant cooling and/or supply system 134 where it is re-cooled by the coolant system 112 before being recirculated back to the coolant inlet 130. Arrows 138 in FIG. 1 represent flow of the coolant. In the embodiment illustrated in FIG. 1, the trough 120 and the screw 122 are both internally cooled with the coolant from the coolant system 112; however, in other embodiments, both components need not be internally cooled, and only the trough 120 or only the screw 122 may be internally cooled. Non-limiting examples of internally cooled troughs and screws are illustrated in FIGS. 3 and 4 and discussed in detail below.

The coolant provided by the coolant system 112 may be various types of coolants as desired, including but not limited to water-based coolants, glycol-based coolants, petrochemical-based coolants, biologically based coolants, molten salt-based coolants, water, ethylene glycol, oils, nitrogen and/or other gas, and/or other fluid coolants as desired. In various embodiments, the coolant system 112 optionally includes one or more flow controllers 136 for controlling the flow of the coolant to and/or from the coolant cooling and/or supply system 134. In the embodiment illustrated in FIG. 1, the coolant system 112 includes one flow controller 136 between the coolant cooling and/or supply system 134 and the coolant inlet 130 to control the flow of the coolant to the coolant inlet 130. When included the one or more flow controllers 136 may be various suitable devices or mechanisms for controlling the flow of the coolant. In the embodiment illustrated, the flow controller 136 is a control valve and optionally includes a flow meter.

As previously mentioned, one or more coolant sensors 116 may optionally be provided to measure or detect one or more characteristics of the coolant within the cooling system 104. The one or more characteristics of the coolant may include but are not limited to a flow rate, a coolant temperature, a fluid pressure, a coolant composition, and/or other characteristics or combinations of characteristics as desired. In the embodiment illustrated, the cooling system 104 includes four coolant sensors 116A-D: the coolant sensor 116A is provided between the cooling and/or supply system supply 134 and the coolant inlet 130 and detects a flow rate of the coolant entering the cooling conveyor 110 (e g., the coolant sensor 116A may be, but does not have to be, a flow meter); the coolant sensor 116B is provided between the coolant cooling and/or supply system 134 and the coolant inlet 130 and detects a temperature of the coolant entering the cooling conveyor 110; the coolant sensor 116C is provided between the coolant outlet 132 and the coolant cooling and/or supply system 134 and detects a flow rate of the coolant exiting the cooling conveyor 110 (e.g., the coolant system 116C may be, but does not have to be, a flow meter); and the coolant sensor 116D is provided between the coolant outlet 132 and the coolant cooling and/or supply system 134 and detects a temperature of the coolant exiting the cooling conveyor 110. In the embodiment illustrated, the coolant sensor 116C is a flow meter that may measure the coolant flow rate on the return side. Optionally, the coolant flow sensor 116C and/or a controller may compare the coolant flow rate on the return side and compare it to a coolant flow rate on the supply side, and based on this comparison, the cooling system 104 may check and/or determine whether there is a leak or other problem with coolant flow through the cooling conveyor 110. As a non-limiting example, if the coolant flow rate detected by the coolant sensor 116C is less than the coolant flow rate on the supply side (e.g., as detected by coolant sensor 116A), such a difference may indicate that some of the coolant is leaking within the cooling conveyor 110.

The aforementioned coolant sensors 116 are provided for illustration purposes, and the number of coolant sensors 116, the type of coolant sensors 116, and the location of the coolant sensors 116 should not be considered limiting, and various combinations of types of coolant sensors 116, numbers of coolant sensors 116, and/or locations of coolant sensors 116 may be used as desired.

Optionally, the cooling system 104 includes the one or more dust sensors 114 for detecting or measuring one or more characteristics of the dust as it is being processed by the decoating system 100 and/or cooled by the cooling system 104. The one or more characteristics may include but are not limited to a dust temperature, a dust volume, /or other characteristics or combinations of characteristics as desired. In the embodiment illustrated in FIG. 1, the cooling system 104 includes three dust sensors 114A-C: the dust sensor 114A measures a temperature of the dust existing the dust cyclone 102; the dust sensor 114B measures a temperature of the dust within the cooling conveyor 110 and proximate to the inlet 124; and the dust sensor 114C measures a temperature of the dust in the outlet 126 of the cooling conveyor 110. Similar to the coolant sensors 116, the number, type, and location of the dust sensors 114 should not be considered limiting, and various combinations of types of dust sensors 114, locations of dust sensors 114, and/or numbers of dust sensors 114 may be used as desired. Moreover, while the cooling system 104 in FIG. 1 is illustrated with both dust sensor 114 and coolant sensors 116, in other embodiments, the cooling system 104 may include only dust sensors 114, only coolant sensors 116, or neither dust sensors 114 nor coolant sensors 116 (e.g., another type of sensor detecting another characteristic of the cooling system may be used).

The controller 118 may be communicatively coupled to the various components of the cooling system 104 for selectively controlling the cooling system 104 such that the cooling system 104 cools the dust at a desired cooling rate. In the embodiment illustrated, the controller 118 is communicatively coupled to the dust sensors 114A-C, the coolant sensors 116A-D, the cooling conveyor 110, and the coolant system 112.

The controller 118 may include one or more of a general-purpose processing unit, a processor specially designed for dust cooling control analysis or applications, a processor specially designed for wireless communications (such as a Programmable System on Chip from Cypress Semiconductor) or other suitable processors or computing devices. A memory may be provided with the controller 118, and when included, the memory may include a long-term storage memory, a short-term working memory, or both. The memory may be used by the controller 118 to store a working set of processor instructions (i.e., the processor may write data to the memory). In some embodiments, the memory could include a disk-based storage device and/or one of several other type of storage mediums including but not limited to a memory disk, USB drive, flash drive, remotely connected storage medium, virtual disk drive, or the like. Various other features including but not limited to a communication circuit/unit, an optional display, an optional speaker, and/or power storage unit may also be included in the controller 118. In some embodiments, some or all of the components of the controller 118 may be included together in a single package or sensor suite, such as within the same enclosure. In additional or alternative aspects, some of the components may be included together in an enclosure and the other components may be separate (i e., the controller 118 may be a distributed system). Other configurations of the controller 118 may be utilized as desired. In some examples, the controller 118 may optionally include or be communicatively coupled to a user interface, and the user interface may optionally include a display. The display may be configured to display notifications, alerts, or any other suitable communications relevant to operating the decoating system 100 to an operator of the decoating system 100.

During a dust cooling process, the controller 118 may receive signals from the dust sensors 114 and/or from the coolant sensors 116. The signals from the dust sensors 114 may include information about the one or more characteristics of the dust while the signals from the coolant sensors 116 may include information about the one or more characteristics of the coolant. In certain examples, the sensors 114 and/or 116 may transmit signals continuously, although in other embodiments, the sensors 114 and/or 116 may transmit signals at a predetermined time, responsive to a detected change in the one or more characteristics, responsive to a request from the controller 118, and/or as otherwise desired.

The controller 118 may analyze the information from a particular sensor and compare the detected characteristic to a predetermined characteristic and/or a detected characteristic from another sensor, and based on this comparison, the controller 118 may determine the cooling rate at which the dust is being cooled, may predict an outlet temperature of the dust exiting the cooling conveyor 110, and/or make other determinations as desired. In certain aspects, the controller 118 may compare the determined cooling rate, predicted cooled temperature, etc. with a desired cooling rate, desired cooled temperature, etc. As a non-limiting example, the desired cooled temperature may be below an ignition temperature of the dust, which in certain embodiments may be from about 175° C. to about 300° C. In various examples, the desired cooled temperature is less than about 150° C., such as less than about 100° C. In some examples, the desired cooled temperature is about 50° C.

Based on the analysis and comparison, the controller 118 may control the cooling conveyor 110 and/or the coolant system 112 such that the cooling system 104 cools the dust at a desired coolant rate and/or such that the dust is cooled to the desired cooled temperature. In certain embodiments, the controller 118 may control of the cooling conveyor 110 and/or the coolant system 112 by controlling one or more of a rotational speed of the screw 122 (e.g., by controlling the driving means 125), a direction of rotation of the screw 122, a temperature of the coolant provided to the cooling conveyor 110 (e.g., by controlling heating or cooling elements at the coolant cooling and/or supply system 134), a flow rate of the coolant (e.g., by controlling the flow controllers 136), and/or as otherwise desired such that the cooling system 104 cools the dust as desired. In this manner, the cooling system 104 may also provide a variable cooling rate that is adjustable as desired.

As a non-limiting example, the controller 118 may control the speed of the cooling conveyor 110 to control the rate at which dust is discharged from the system and/or such that the rate at which dust is discharged remains proportional to the dust within the cooling conveyor 110. As an example, the amount of dust from the cyclone 102 and/or characteristics of the dust from the cyclone 102 may not be constant during a decoating process, and the controller 118 may control the speed of the cooling conveyor 110 such that the cooling conveyor 110 does not become flooded or plugged with dust. In some embodiments, the controller 118 may control the cooling conveyor 110 such that the cooling conveyor 110 is at least a minimum conveyor speed, which may correspond to the minimum speed needed to minimize dust plugging of the conveyor and/or overflow.

As another non-limiting example, the controller 118 may receive the temperature of the dust from the dust sensor 114C and compare the received temperature to an expected temperature and/or to the temperature received from the dust sensor 114B (e.g., to determine a change in temperature of the dust). Based on the comparison, if the controller 118 determines that the current cooling process is or will achieve the desired cooling rate and/or desired cooled temperature, the controller 118 will not change the operating conditions of the cooling system 104. However, if the controller 118 determines that the current cooling process is not achieving the desired cooling rate and/or desired cooled temperature, the controller 118 may adjust one or more components of the cooling system to adjust the cooling rate. As a non-limiting example, the controller 118 may decrease the rotational speed of the screw 122 to increase the duration of the dust within the cooling conveyor 110 (and thus increase the amount the cooling provided) if the cooling rate is too slow and/or the predicted cooled temperature is above the desired cooled temperature. Conversely, the controller 118 may increase the rotational speed of the screw 122 to decrease the duration of the dust within the cooling conveyor 110 (and thus decrease the amount of cooling provided) if the cooling rate is too high and/or the predicted cooled temperature is below the desired cooled temperature.

As another non-limiting example, the controller 118 may receive the temperature of the coolant from the coolant sensor 116D and compare the received temperature to an expected temperature and/or to the temperature received from the coolant sensor 116B (e.g., to determine a change in temperature of the coolant). Similar to the aforementioned process, the controller 118 may use these temperatures to determine whether the current cooling process is or will achieve the desired cooling rate and/or desired cooled temperature and implement controls of the cooling conveyor 110 and/or the coolant system 112 as desired.

Other non-limiting examples of control by the controller 118 include, but are not limited to, controlling the flow of coolant such that the dust temperature is cooled from the inlet temperature to the desired cooled temperature, controlling the coolant dispenser(s) 242 such that coolant is directly dispensed onto the dust if the dust is at certain temperatures (e g., above 200° C. at the inlet and/or above 50° C. at the outlet), controlling the flow of coolant based on a coolant chiller being on or off, controlling the flow of coolant based on coolant pumps being on or off, and/or based on hi-lo level sensors of coolant within a storage container. Various other controls of the cooling conveyor 110 and/or the coolant system 112 may be implemented by the controller 118 based on the information from the dust sensor(s) 114 and/or the coolant sensor(s) 116 as desired.

Referring to FIG. 1, a decoating process or method with the decoating system 100 includes receiving metal scrap into the kiln of the decoating system 100, and heated gas is injected into the kiln to raise the temperature within the kiln and vaporize and/or thermally crack coatings and/or other contaminants without melting the metal scrap. In some examples, the oxygen concentration within the decoating system 100 is maintained at a low level (such as from about 6% to about 8% oxygen) such that the organic coatings do not ignite. As a non-limiting example, within the decoating system 100, the atmosphere may be 7% oxygen such that the organic compounds do not ignite even though they are at elevated temperatures due to the decoating process. The decoated scrap metal is removed from the kiln for further processing and ultimately processing into new aluminum products. As the scrap progresses through the kiln, it is heated by the gases, thereby cooling said gases. This thermal profile results in certain organic compounds that had previously vaporized to re-condense onto the surface of particulate matter.

Exhaust gas containing the vaporized organic compounds and particulate matter exits the kiln and is directed to the dust cyclone 102 (or other suitable solid/gas separator). In certain embodiments, the temperature of the gas directed from the kiln to the dust cyclone 102 may be from about 250° C. to about 400° C. Within the dust cyclone 102, larger particulates containing condensed organic compounds are removed from the exhaust gas as dust and ultimately discharged from the dust cyclone 102 for disposal. From the dust cyclone 102, the exhaust gas is directed into the afterburner, which incinerates the remaining organic compounds within the exhaust gas, and discharges a heated gas to the exhaust system, the atmosphere, or back into the kiln.

The particulate matter separated from the exhaust gas by the dust cyclone 102 is discharged as dust out the outlet 106 of the dust cyclone 102. Traditionally, the dust discharged from the dust cyclone 102 is collected with a bin or hopper. However, the dust discharged from the dust cyclone 102 and retained within the hopper is susceptible to combustion and the formation of fires because the dust exits the dust cyclone at a relatively high temperature, and it can contain low temperature ignition compounds and catalyzing materials and compounds. This is exacerbated by the dust particles being loosely packed, the rate of air ingress into a pile of dust is relatively high (i.e., more air can infiltrate a pile of dust such that more dust is in contact with air), and the rate of heat conduction away from a local reaction site is relatively low. These dust fires are very difficult to extinguish, even with water or fire extinguishers. Moreover, if water were used to wet the dust to make a slurry mixture of the water and dust, the mixture may be costly to dispose of due to the content of the slurry mixture as well as the volume of the material. The process may further be costly to implement because of the quantity of water needed on a daily basis, and the mixture may present potential safety and environmental issues.

As illustrated in FIG. 1, rather than discharging the dust from the dust cyclone 102 directly into a bin or hopper, the process includes discharging the dust from the dust cyclone 102 into the cooling system 104. Optionally, the dust may be discharged through a chute 140, although in other embodiments the chute 140 may be omitted. The cooling system 104 reduces the temperature of the dust from an inlet temperature to the desired cooled temperature. As mentioned, in some embodiments, the dust discharged from the dust cyclone 102 may be discharged at a temperature (i.e., the inlet temperature) of from about 250° C. to about 400° C. The dust discharged from the cooling system 104 may be discharged at the desired cooling temperature. The desired cooled temperature is a temperature below an ignition temperature of the dust, which in certain embodiments may be from about 175° C. to about 300° C. In various examples, the cooled temperature is less than about 150° C., such as less than about 100° C. In some examples, the cooled temperature is about 50° C.

In various embodiments, the process may include measuring a characteristic of the dust and/or measuring a characteristic of the coolant and controlling the cooling from the cooling system 104 based on the measured dust characteristic and/or the measured coolant characteristic. As previously mentioned, the characteristic of the dust may include but is not limited to a dust temperature and/or a dust volume, and the characteristic of the coolant may include but is not limited to a flow rate, a coolant temperature, a fluid pressure, and/or a coolant composition. Controlling the cooling from the cooling system 104 may include but is not limited to controlling a rate of rotation of the screw 122 within the trough 120 of the cooling conveyor 110, and/or controlling a flow rate of the coolant supplied to the cooling conveyor 110. In certain embodiments, such control may accommodate and cool the dust despite continuously changing dust temperature and/or continuously changing dust volumes. By cooling the dust to a desired cooling temperature (e g., a dust processing temperature) below an ignition temperature of the dust, the risk of dust fires is reduced or eliminated, and the dust may be further processed as desired.

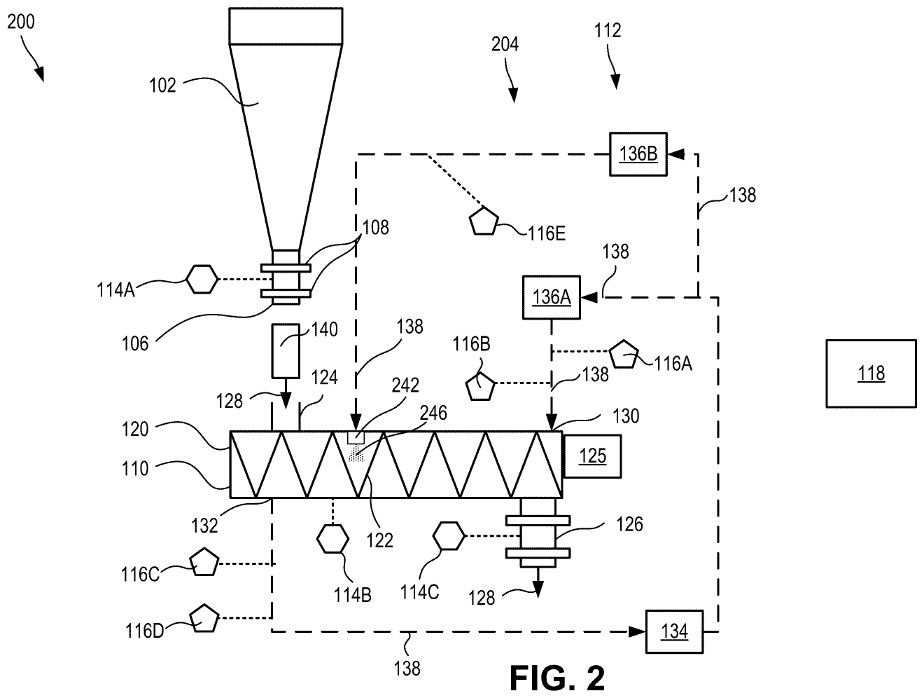

FIG. 2 illustrates another embodiment of a decoating system 200 according to various embodiments. The decoating system 200 is substantially similar to the decoating system 100 and includes the dust cyclone 102 and a cooling system 204. The cooling system 204 is similar to the cooling system 104 except that the cooling system 204 further includes one or more coolant dispensers 242 that selectively dispense the coolant 246 within the cooling conveyor 110 and/or directly onto the dust within the cooling conveyor 110. In the embodiment illustrated, a single coolant dispenser 242 is provided, and the coolant dispenser 242 is a sprayer. However, the number, location, and type of coolant dispenser should not be considered limiting on the disclosure.

In certain embodiments, the coolant dispenser(s) 242 that dispenses the coolant 246 within the cooling conveyor 110 may allow for direct cooling of the dust within the cooling conveyor 110. In certain embodiments, the coolant dispenser(s) 242 optionally may provide supplementary cooling for the decoating system 200. Optionally, the coolant dispenser(s) 242 may allow for the length of the cooling conveyor 110 to be shortened such that the system is compact and occupies minimal floor space in a working environment. In some embodiments, the coolant dispenser(s) 242 optionally may be controlled to extinguish sparks in the dust within the cooling conveyor 110 that would otherwise trigger a dust fire after the dust is discharged. In some embodiments, the cooling dispenser(s) 242 may continuously dispense coolant, although in other embodiments, the coolant dispenser(s) 242 are selectively controlled to dispense the coolant and they need not be continuously dispensing coolant. As a non-limiting example, the coolant dispenser(s) 242 optionally may be controlled such that the coolant is dispensed only when the temperature of the dust is above a certain temperature at the inlet 124 and/or the outlet 126 of the cooling conveyor 110. In other embodiments, the coolant dispenser(s) 242 may be controlled as otherwise desired.

In this embodiment, the coolant system 112 includes two flow controllers 116A-B, where the flow controller 136A controls the flow of the coolant to the cooling conveyor 110 and the flow controller 136B controls the flow of the coolant to the coolant dispenser 242. In this embodiment, an additional coolant sensor 116E is provided to measure or detect a characteristic of the coolant flowing to the coolant dispenser 242. In the embodiment illustrated, the coolant sensor 116E is a flow meter, although other types of coolant sensors may be utilized as desired.

In various embodiments, the controller 118 may receive information from the coolant sensor 116E about the coolant provided to the coolant dispenser 242 and control the various components of the cooling system 204 based at least partially on this information. Additionally, or alternatively, the controller 118 may selectively control the coolant dispenser 242 to control the coolant that is dispensed by the coolant dispenser 242 and such that the desired cooling rate and/or the desired cooled temperature is achieved. As some non-limiting examples, the controller may control a spray pattern of the coolant 246 from the coolant dispenser 242, a spray angle of the coolant 246 from the coolant dispenser 242, a flow rate or volume of coolant flowing through the coolant dispenser 242, a temperature of the coolant dispensed by the coolant dispenser 242, and/or as otherwise desired. In some non-limiting examples, a minimum amount of coolant may need to be sprayed directly into the cooling conveyor 110 for direct and efficient dust cooling, and the controller 118 may control the coolant dispenser 242 to dispense a particular volume of coolant and/or with at least a minimum dispensing rate.

As previously mentioned, in certain embodiments, one or more components of the cooling conveyor 110 may be internally cooled. FIG. 3 illustrates a non-limiting example of a screw 322 for a screw conveyor that is internally cooled, and FIG. 4 illustrates a non-limiting example of a trough 420 for a screw conveyor that is internally cooled. The screw 322 and the trough 420 are provided for illustrative purposes only, and other types of internally cooled screws and/or troughs may be utilized as desired.

Referring to FIG. 3, in certain embodiments, the internally cooled screw 322 may include a hollow body 348 having helical flights 350. In this embodiment, a coolant at a lower temperature than the dust is introduced into the hollow body 348 into a coolant inlet 330 (coolant flow is represented by arrows 352). As the coolant flows through the hollow body 348, the temperature of the coolant increases due to contact of the screw 322 with the dust and the temperature of the dust decreases due to contact with flights 350 and/or other surface of the screw 322 that is cooled by the low temperature coolant. The heated coolant is then directed from the hollow body 348 out a coolant outlet 332 (coolant flow represented by arrow 354).

Referring to FIG. 4, in various embodiments, the trough 420 is hollow and defines internal passages 456 for the coolant to flow such that dust that is exposed to a surface 458 during operation is cooled by the trough 420. Optionally, the coolant may be introduced into the trough 420 through an inlet 430 and then directed through the passages 456, the flow which is represented by arrows 462.

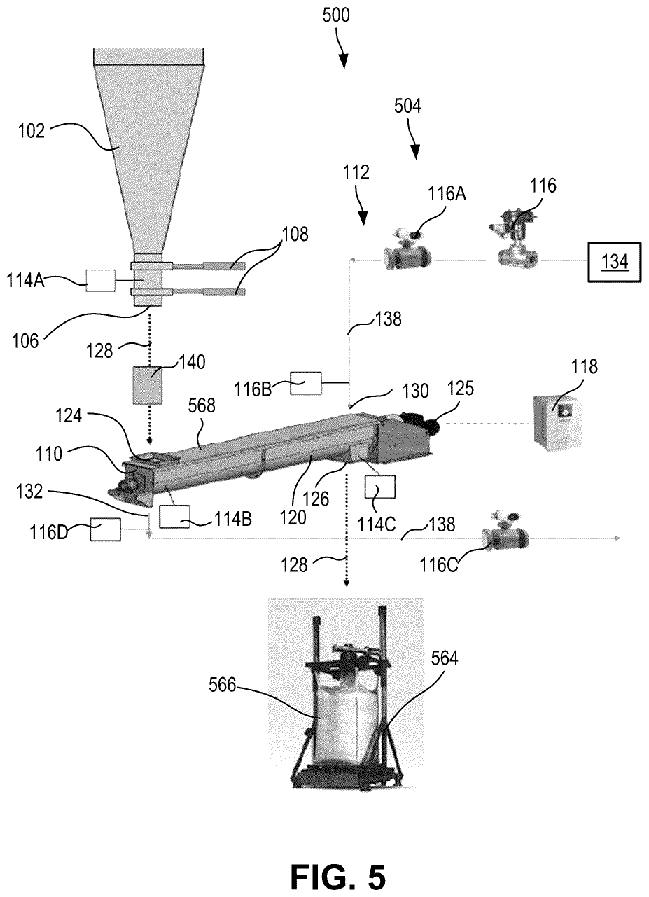

FIG. 5 illustrates another example of a decoating system 500 according to various embodiments. The decoating system 500 is similar to the decoating system 100 and includes the dust cyclone 102 and a cooling system 504. The cooling system 504 is substantially similar to the cooling system 104 except that the coolant system 112 does not include a return path to re-cool the coolant after the coolant has exited the cooling conveyor 110. In addition, the cooling conveyor 110 further includes a cover 568 that covers the screw (not visible in FIG. 5) within the trough 120.

The cooling system 504 additionally includes a dust weighing and alarm system 564 compared to the cooling system 104. In this embodiment, the dust weighing and alarm system 564 may support a dust holder 566 (e.g., a container, bag, etc.) that receives dust that has been discharged from the cooling conveyor 110. Optionally, the dust weighing and alarm system 564 may be communicatively coupled to the controller 118, although it need not be in other embodiments. In certain aspects, the dust weighing and alarm system 564 may weigh the dust and/or measure at least one characteristic of the dust and generate an alarm based on the measured weight and/or another characteristic being outside of a predetermined threshold. As a non-limiting example, the dust weighing and alarm system 564 may generate an alarm (or the controller 118 may cause the dust weighing and alarm system 564 to generate an alarm) based on the dust being too heavy for transport, the dust being too hot for transport, the dust having a water content outside of an environmental limit, the dust bag needing to be replaced with a new dust bag, and/or as otherwise desired. In other embodiments, the dust weighing and alarm system 564 may be omitted.

A collection of exemplary embodiments is provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A cooling system comprising: a sensor configured to measure a dust characteristic of dust discharged from a dust cyclone of a decoating system; and a cooling conveyor configured to receive the dust from the dust cyclone and cool the dust at a cooling rate, wherein the cooling system is configured to control the cooling rate based on the measured dust characteristic.

Illustration 2. The cooling system of any preceding or subsequent illustrations or combination of illustrations, wherein the cooling conveyor is configured to cool the dust from an inlet temperature to a cooled temperature, and wherein the cooled temperature is less than or equal to 150° C.

Illustration 3. The cooling system of any preceding or subsequent illustrations or combination of illustrations, wherein the cooled temperature is from 50° C. to 150° C., inclusive.

Illustration 4. The cooling system of any preceding or subsequent illustrations or combination of illustrations, wherein the cooling conveyor comprises a screw rotatably positioned in a trough, and wherein the cooling system is configured to control the cooling rate by controlling a rate of rotation of the screw within the trough.

Illustration 5. The cooling system of any preceding or subsequent illustrations or combination of illustrations, wherein the cooling system is configured to control the cooling rate by adjusting or controlling a conveyor speed to control a duration of the dust within the cooling conveyor.

Illustration 6. The cooling system of any preceding or subsequent illustrations or combination of illustrations, further comprising at least one coolant dispenser configured to dispense a coolant onto the dust within the cooling conveyor, and wherein the cooling system is configured to control the cooling rate by controlling a volume, a flow rate, or a temperature of the coolant dispensed by the at least one coolant dispenser.

Illustration 7. The cooling system of any preceding or subsequent illustrations or combination of illustrations, further comprising a controller communicatively coupled to the sensor and the cooling conveyor, wherein the controller is configured to control the cooling rate of the cooling conveyor based on the measured dust characteristic.

Illustration 8. The cooling system of any preceding or subsequent illustrations or combination of illustrations, wherein the dust characteristic comprises at least one of a dust temperature or a dust volume.

Illustration 9. The cooling conveyor of any preceding or subsequent illustrations or combination of illustrations, wherein the sensor is upstream from the cooling conveyor and measures the dust characteristic upstream from an inlet of the cooling conveyor.

Illustration 10. The cooling system of any preceding or subsequent illustrations or combination of illustrations, wherein the cooling conveyor comprises an inlet and an outlet, and wherein the sensor configured to measure the dust characteristic between the inlet and the outlet.

Illustration 11 The cooling system of any preceding or subsequent illustrations or combination of illustrations, further comprising a coolant dispenser configured to dispense a coolant onto the dust within the cooling conveyor, wherein the cooling system is configured to control the cooling rate by controlling the coolant dispenser to dispense the coolant at a minimum dispensing rate.

Illustration 12 The cooling system of any preceding or subsequent illustrations or combination of illustrations, wherein the cooling system is configured to control the cooling rate by controlling at least one of: a cooling characteristic of a coolant directly contacting the dust; or a cooling characteristic of a coolant indirectly cooling the dust.

Illustration 13. A decoating system comprising a dust cyclone and the cooling system of any preceding or subsequent illustrations or combination of illustrations.

Illustration 14. A decoating system comprising: a dust cyclone configured to receive an exhaust gas from a decoating kiln, filter particulate matter from the exhaust gas as dust, and discharge the dust; and a cooling system comprising a sensor and a cooling conveyor, wherein the sensor is configured to measure a dust characteristic of the dust discharged from the dust cyclone, wherein the cooling conveyor is configured to receive the dust discharged from the dust cyclone and cool the dust at a cooling rate, and wherein the cooling system is configured to control the cooling rate based on the measured dust characteristic.

Illustration 15. The decoating system of any preceding or subsequent illustrations or combination of illustrations, wherein the measured dust characteristic comprises at least one of a dust temperature or a dust volume.

Illustration 16. The decoating system of any preceding or subsequent illustrations or combination of illustrations, wherein the cooling system is configured to control the cooling rate by controlling at least one of: a rate of rotation of a screw within a trough of the cooling conveyor; a flow rate of a coolant supplied to the cooling conveyor, a temperature of a coolant supplied to the cooling conveyor; a volume of a coolant dispensed by at least one coolant dispenser onto the dust within the cooling conveyor; a flow rate of a coolant dispensed by at least one coolant dispenser onto the dust within the cooling conveyor; or a temperature of the coolant dispensed by at least one coolant dispenser onto the dust within the cooling conveyor.

Illustration 17. The decoating system of any preceding or subsequent illustrations or combination of illustrations, further comprising a controller communicatively coupled to the sensor and the cooling conveyor, wherein the controller is configured to control the cooling rate of the cooling conveyor based on the measured dust characteristic.

Illustration 18. A method of cooling dust from a dust cyclone of a decoating system with a cooling system, the method comprising: measuring a dust characteristic of the dust discharged from the dust cyclone and into a cooling conveyor of the cooling system; and advancing the dust along the cooling conveyor and cooling the dust at a cooling rate based on the measured dust characteristic.

Illustration 19 The method of any preceding or subsequent illustrations or combination of illustrations, wherein measuring the dust characteristic comprises measuring at least one of a dust temperature or a dust volume.

Illustration 20. The method of any preceding or subsequent illustrations or combination of illustrations, wherein cooling the dust at the cooling rate comprises adjusting the cooling rate based on the measured dust characteristic, and wherein adjusting the cooling rate comprises controlling at least one of: a rate of rotation of a screw within a trough of the cooling conveyor; a flow rate of a coolant supplied to the cooling conveyor; a temperature of a coolant supplied to the cooling conveyor; a volume of a coolant dispensed by at least one coolant dispenser onto the dust within the cooling conveyor; a flow rate of a coolant dispensed by at least one coolant dispenser onto the dust within the cooling conveyor; or a temperature of the coolant dispensed by at least one coolant dispenser onto the dust within the cooling conveyor.

Illustration 21. The method of any preceding or subsequent illustrations or combination of illustrations, wherein cooling the dust at the cooling rate comprises receiving the measured dust characteristic, determining a cooling rate such that the dust has a predefined cooled temperature at an outlet of the cooling conveyor, and controlling the cooling system to cool the dust at the determined cooling rate.

Illustration 22. The method of any preceding or subsequent illustrations or combination of illustrations, wherein the predefined cooled temperature is less than or equal to 150° C.

Illustration 23. A cooling system comprising: a cooling conveyor comprising a trough and a screw within the trough, wherein the screw is rotatable within the trough, wherein at least one of the screw or the trough is internally cooled with a coolant and comprises a coolant inlet and a coolant outlet, and wherein the cooling conveyor is configured to receive dust discharged from a dust cyclone of a decoating system and cool the dust at a cooling rate; and a sensor configured to measure a characteristic of the coolant, wherein the cooling system is configured to control the cooling rate based on the measured characteristic of the coolant.

Illustration 24. The cooling system of any preceding or subsequent illustrations or combination of illustrations, wherein the sensor is configured to measure the characteristic of the coolant before the coolant enters the coolant inlet.

Illustration 25 The cooling system of any preceding or subsequent illustrations or combination of illustrations, wherein the sensor is configured to measure the characteristic of the coolant after the coolant exits the coolant outlet.

Illustration 26. The cooling system of any preceding or subsequent illustrations or combination of illustrations, wherein the cooling system is configured to control the cooling rate by controlling at least one of: a rate of rotation of a screw within a trough of the cooling conveyor; a flow rate of the coolant supplied to the cooling conveyor; a temperature of the coolant supplied to the cooling conveyor; a volume of the coolant dispensed by at least one coolant dispenser onto the dust within the cooling conveyor; a flow rate of the coolant dispensed by at least one coolant dispenser onto the dust within the cooling conveyor; or a temperature of the coolant dispensed by at least one coolant dispenser onto the dust within the cooling conveyor.

Illustration 27. The cooling system any preceding or subsequent illustrations or combination of illustrations, further comprising a dust weighing and alarm system, the dust weighing and alarm system configured to; receive discharged dust from the cooling conveyor; measure at least one characteristic of the dust; and generate an alarm based on the measured at least one characteristic being outside of a predetermined threshold.

Illustration 28. The cooling system any preceding or subsequent illustrations or combination of illustrations, wherein the at least one characteristic is a weight of the discharged dust.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. While the systems and methods described herein can be used with any metal, they may be especially useful with aluminum or aluminum alloys.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A cooling system comprising:
a sensor configured to measure a dust characteristic of dust discharged from a dust cyclone of a decoating system; and
a cooling conveyor configured to receive the dust from the dust cyclone and cool the dust at a cooling rate, wherein the cooling system is configured to control the cooling rate based on the measured dust characteristic.

2. The cooling system of claim 1, wherein the cooling conveyor is configured to cool the dust from an inlet temperature to a cooled temperature, and wherein the cooled temperature is less than or equal to 150° C.

3. The cooling system of claim 2, wherein the cooled temperature is from 50° C. to 150° C., inclusive.

4. The cooling system of claim 1, wherein the cooling conveyor comprises a screw rotatably positioned in a trough, and wherein the cooling system is configured to control the cooling rate by controlling a rate of rotation of the screw within the trough.

5. The cooling system of claim 1, wherein the cooling system is configured to control the cooling rate by adjusting a conveyor speed to control a duration of the dust within the cooling conveyor.

6. The cooling system of claim 1, further comprising at least one coolant dispenser configured to dispense a coolant onto the dust within the cooling conveyor, and wherein the cooling system is configured to control the cooling rate by controlling a volume, a flow rate, or a temperature of the coolant dispensed by the at least one coolant dispenser.

7. The cooling system of claim 1, further comprising a controller communicatively coupled to the sensor and the cooling conveyor, wherein the controller is configured to control the cooling rate of the cooling conveyor based on the measured dust characteristic.

8. The cooling system of claim 1, wherein the dust characteristic comprises at least one of a dust temperature or a dust volume.

9. The cooling conveyor of claim 1, wherein the sensor is upstream from the cooling conveyor and measures the dust characteristic upstream from an inlet of the cooling conveyor.

10. The cooling system of claim 1, wherein the cooling conveyor comprises an inlet and an outlet, and wherein the sensor is configured to measure the dust characteristic between the inlet and the outlet.

11. The cooling system of claim 1, further comprising a coolant dispenser configured to dispense a coolant onto the dust within the cooling conveyor, wherein the cooling system is configured to control the cooling rate by controlling the coolant dispenser to dispense the coolant at a minimum dispensing rate.

12. The cooling system of claim 1, wherein the cooling system is configured to control the cooling rate by controlling at least one of:
a cooling characteristic of a coolant directly contacting the dust; or
a cooling characteristic of a coolant indirectly cooling the dust.

13. A decoating system comprising a dust cyclone and the cooling system of claim 1, wherein the dust cyclone is configured to receive an exhaust gas from a decoating kiln, filter particulate matter from the exhaust gas as dust, and discharge the dust.

14. A method of cooling dust from a dust cyclone of a decoating system with a cooling system, the method comprising:
measuring a dust characteristic of the dust discharged from the dust cyclone and into a cooling conveyor of the cooling system; and
advancing the dust along the cooling conveyor and cooling the dust at a cooling rate based on the measured dust characteristic.

15. The method of claim 14, wherein measuring the dust characteristic comprises measuring at least one of a dust temperature or a dust volume.

16. The method of claim 14, wherein cooling the dust at the cooling rate comprises adjusting the cooling rate based on the measured dust characteristic, and wherein adjusting the cooling rate comprises controlling at least one of:
a rate of rotation of a screw within a trough of the cooling conveyor;
a flow rate of a coolant supplied to the cooling conveyor;
a temperature of the coolant supplied to the cooling conveyor;
a volume of the coolant dispensed by at least one coolant dispenser onto the dust within the cooling conveyor;
a flow rate of the coolant dispensed by at least one coolant dispenser onto the dust within the cooling conveyor; or
a temperature of the coolant dispensed by at least one coolant dispenser onto the dust within the cooling conveyor.

17. A cooling system comprising:
a cooling conveyor comprising a trough and a screw within the trough, wherein the screw is rotatable within the trough, wherein at least one of the screw or the trough is internally cooled with a coolant and comprises a coolant inlet and a coolant outlet, and wherein the cooling conveyor is configured to receive dust discharged from a dust cyclone of a decoating system and cool the dust at a cooling rate; and
a sensor configured to measure a characteristic of the coolant, wherein the cooling system is configured to control the cooling rate based on the measured characteristic of the coolant.

18. The cooling system of claim 17, wherein the sensor is configured to measure the characteristic of the coolant before the coolant enters the coolant inlet and/or after the coolant exits the coolant outlet.

19. The cooling system of claim 17, wherein the cooling system is configured to control the cooling rate by controlling at least one of:
a rate of rotation of a screw within a trough of the cooling conveyor;
a flow rate of the coolant supplied to the cooling conveyor;
a temperature of the coolant supplied to the cooling conveyor;
a volume of the coolant dispensed by at least one coolant dispenser onto the dust within the cooling conveyor;
a flow rate of the coolant dispensed by at least one coolant dispenser onto the dust within the cooling conveyor; or
a temperature of the coolant dispensed by at least one coolant dispenser onto the dust within the cooling conveyor.

20. The cooling system of claim 17, further comprising a dust weighing and alarm system, the dust weighing and alarm system configured to:
receive discharged dust from the cooling conveyor;
measure at least one characteristic of the dust; and
generate an alarm based on the measured at least one characteristic being outside of a predetermined threshold.
